(19) United States
(12) Patent Application Publication
(10) Pub. No.: US 2007/0193478 A1
(43) Pub. Date: Aug. 23, 2007

(54) Additive building material mixtures containing microparticles having non-polar shells

(75) Inventors: Jan Hendrik Schattka, Hanau (DE); Holger Kautz, Hanau (DE); Gerd Lohden, Hanau (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: ROEHM GBMH & CO. KG, Darmstadt (DE)

(21) Appl. No.: 11/387,803

(22) Filed: Mar. 24, 2006

(30) Foreign Application Priority Data
Feb. 23, 2006 (DE) 10 2006 008 967.7

(51) Int. Cl. C04B 24/00

(52) U.S. Cl. 106/802; 524/2

(57) ABSTRACT

The present invention relates to the use of polymeric microparticles having non-polar shells in hydraulically setting building material mixtures for the purpose of enhancing their frost resistance and cyclical freeze/thaw durability.

The present invention relates to the use of polymeric microparticles in hydraulically setting building material mixtures for the purpose of enhancing their frost resistance and cyclical freeze/thaw durability.

Decisive factors affecting the resistance of concrete to frost and to cyclical freeze/thaw under simultaneous exposure to thawing agents are the imperviousness of its microstructure, a certain strength of the matrix, and the presence of a certain pore microstructure. The microstructure of a cement-bound concrete is traversed by capillary pores (radius: 2 μm-2 mm) and gel pores (radius: 2-50 nm). Water present in these pores differs in its state as a function of the pore diameter. Whereas water in the capillary pores retains its usual properties, that in the gel pores is classified as condensed water (mesopores: 50 nm) and adsorptively bound surface water (micropores: 2 nm), the freezing points of which may for example be well below −50° C. [M. J. Setzer, Interaction of water with hardened cement paste, Ceramic Transactions 16 (1991) 415-39]. Consequently, even when the concrete is cooled to low temperatures, some of the water in the pores remains unfrozen (metastable water). For a given temperature, however, the vapour pressure over ice is lower than that over water. Since ice and metastable water are present alongside one another simultaneously, a vapour-pressure gradient develops which leads to diffusion of the still-liquid water to the ice and to the formation of ice from said water, resulting in removal of water from the smaller pores or accumulation of ice in the larger pores. This redistribution of water as a result of cooling takes place in every porous system and is critically dependent on the type of pore distribution.

The artificial introduction of microfine air pores in the concrete hence gives rise primarily to what are called expansion spaces for expanding ice and ice-water. Within these pores, freezing water can expand or internal pressure and stresses of ice and ice-water can be absorbed without formation of microcracks and hence without frost damage to the concrete. The fundamental way in which such air-pore systems act has been described, in connection with the mechanism of frost damage to concrete, in a large number of reviews [Schulson, Erland M. (1998) Ice damage to concrete. CRREL Special Report 98-6; S. Chatterji, Freezing of air-entrained cement-based materials and specific actions of air-entraining agents, Cement & Concrete Composites 25 (2003) 759-65; G. W. Scherer, J. Chen & J. Valenza, Methods for protecting concrete from freeze damage, U.S. Pat. No. 6,485,560 B1 (2002); M. Pigeon, B. Zuber & J. Marchand, Freeze/thaw resistance, Advanced Concrete Technology 2 (2003) November 1-November 17; B. Erlin & B. Mather, A new process by which cyclic freezing can damage concrete—the Erlin/Mather effect, Cement & Concrete Research 35 (2005) 1407-11].

A precondition for improved resistance of the concrete on exposure to the freezing and thawing cycle is that the distance of each point in the hardened cement from the next artificial air pore does not exceed a defined value. This distance is also referred to as the “Powers spacing factor” [T. C. Powers, The air requirement of frost-resistant concrete, Proceedings of the Highway Research Board 29 (1949) 184-202]. Laboratory tests have shown that exceeding the critical “Powers spacing factor” of 500 μm leads to damage to the concrete in the freezing and thawing cycle. In order to achieve this with a limited air-pore content, the diameter of the artificially introduced air pores must therefore be less than 200-300 μm [K. Snyder, K. Natesaiyer & K. Hover, The stereological and statistical properties of entrained air voids in concrete: A mathematical basis for air void systems characterization, Materials Science of Concrete VI (2001) 129-214].

The formation of an artificial air-pore system depends critically on the composition and the conformity of the aggregates, the type and amount of the cement, the consistency of the concrete, the mixer used, the mixing time, and the temperature, but also on the nature and amount of the agent that forms the air pores, the air entrainer. Although these influencing factors can be controlled if account is taken of appropriate production rules, there may nevertheless be a multiplicity of unwanted adverse effects, resulting ultimately in the concrete's air content being above or below the desired level and hence adversely affecting the strength or the frost resistance of the concrete.

Artificial air pores of this kind cannot be metered directly; instead, the air entrained by mixing is stabilized by the addition of the aforementioned air entrainers [L. Du & K. J. Folliard, Mechanism of air entrainment in concrete, Cement & Concrete Research 35 (2005) 1463-71]. Conventional air entrainers are mostly surfactant-like in structure and break up the air introduced by mixing into small air bubbles having a diameter as far as possible of less than 300 μm, and stabilize them in the wet concrete microstructure. A distinction is made here between two types.

One type—for example sodium oleate, the sodium salt of abietic acid or Vinsol resin, an extract from pine roots—reacts with the calcium hydroxide of the pore solution in the cement paste and is precipitated as insoluble calcium salt. These hydrophobic salts reduce the surface tension of the water and collect at the interface between cement particle, air and water. They stabilize the microbubbles and are therefore encountered at the surfaces of these air pores in the concrete as it hardens.

The other type—for example sodium lauryl sulfate (SDS) or sodium dodecyl-phenylsulphonate—reacts with calcium hydroxide to form calcium salts which, in contrast, are soluble, but which exhibit an abnormal solution behaviour. Below a certain critical temperature the solubility of these surfactants is very low, while above this temperature their solubility is very good. As a result of preferential accumulation at the air/water boundary they likewise reduce the surface tension, thus stabilize the microbubbles, and are preferably encountered at the surfaces of these air pores in the hardened concrete.

The use of these prior-art air entrainers is accompanied by a host of problems [L. Du & K. J. Folliard, Mechanism of air entrainment in concrete, Cement & Concrete Research 35 (2005) 1463-71]. For example, prolonged mixing times, different mixer speeds and altered metering sequences in the case of ready-mix concretes result in the expulsion of the stabilized air (in the air pores).

The transporting of concretes with extended transport times, poor temperature control and different pumping and conveying equipment, and also the introduction of these concretes in conjunction with altered subsequent processing, jerking and temperature conditions, can produce a significant change in an air-pore content set beforehand. In the worst case this may mean that a concrete no longer complies with the required limiting values of a certain exposure class and has therefore become unusable [EN 206-1 (2000), Concrete—Part 1: Specification, performance, production and conformity].

The amount of fine substances in the concrete (e.g. cement with different alkali content, additions such as flyash, silica dust or colour additions) likewise adversely affects air entrainment. There may also be interactions with flow improvers that have a defoaming action and hence expel air pores, but may also introduce them in an uncontrolled manner.

All of these influences which complicate the production of frost-resistant concrete can be avoided if, instead of the required air-pore system being generated by means of abovementioned air entrainers with surfactant-like structure, the air content is brought about by the admixing or solid metering of polymeric microparticles (hollow microspheres) [H. Sommer, A new method of making concrete resistant to frost and de-icing salts, Betonwerk & Fertigteiltechnik 9 (1978) 476-84]. Since the microparticles generally have particle sizes of less than 100 μm, they can also be distributed more finely and uniformly in the concrete microstructure than can artificially introduced air pores. Consequently, even small amounts are sufficient for sufficient resistance of the concrete to the freezing and thawing cycle.

The use of polymeric microparticles of this kind for improving the frost resistance and cyclical freeze/thaw durability of concrete is already known from the prior art [cf. DE 2229094 A1, U.S. Pat. No. 4,057,526 B1, U.S. Pat. No. 4,082,562 B1, DE 3026719 A1]. The microparticles described therein are notable in particular for the fact that they possess a void which is smaller than 200 μm (diameter) and that this hollow core is composed of air (or a gaseous substance). This likewise includes porous microparticles of the 100 μm scale which may possess a multiplicity of relatively small voids and/or pores.

With the use of hollow microparticles for artificial air entrainment in concrete, two factors proved to be disadvantageous for the implementation of this technology on the market. Relatively high doses are required in order to achieve satisfactory resistance of the concrete to freezing and thawing cycles. The object on which the present invention is based was therefore that of providing a means of improving the frost resistance and cyclical freeze/thaw durability for hydraulically setting building material mixtures that develops its full activity even in relatively low doses.

The object has been achieved through the use of polymeric microparticles, containing a void, in hydraulically setting building material mixtures, characterized in that the shell of the microparticles is composed more than 99% by weight of monomers having a water-solubility of less than 10⁻¹ mol/l.

Unless otherwise indicated, the solubilities referred to in this specification are always those in water at 20° C.

As a result of the predominant use of monomers with very poor water-solubility, microparticles are obtained which have a very non-polar surface.

Surprisingly it has been found that through the use of such microparticles it is possible to achieve extremely good activity in the context of increasing the resistance towards frost and freeze/thaw cycling. The effect is significantly better than if using particles having a more polar surface.

As an explanation of this unexpected effect—without any intention that this theory should restrict the scope of the invention—it is assumed that microparticles of this kind with a non-polar surface exhibit poor attachment to the building material mixture. As a result of this it is possible for capillary pores to form at the interface between microparticles and building material matrix, these pores contributing to an increase in resistance to frost and freeze/thaw cycling.

The shell is composed in accordance with the invention more than 99% by weight of monomers having a water-solubility of less than 10⁻¹ mol/l. The shell is preferably composed more than 99.5% by weight of such monomers. With particular preference the shell is composed exclusively of such monomers.

Since the inventive effect of the non-polar shell is apparently related to the non-polar surface, it is sufficient if, in the case of a multi-shell structure of the microparticle, the outermost shell satisfies the condition of being composed more than 99% by weight of monomers having a water-solubility of less than 10⁻¹ mol/l. In this case as well a monomer composition with 99.5% of these monomers is preferred, and the exclusive use of these monomers in the outermost shell is particularly preferred.

The shell, where appropriate the outer shell, is preferably composed of styrene.

In a further preferred embodiment of the invention the shell, where appropriate the outer shell, is composed of styrene and/or n-hexyl (meth)acrylate and/or n-butyl (meth)acrylate and/or isobutyl (meth)acrylate and/or propyl (meth)acrylate and/or ethyl methacrylate and/or ethylhexyl (meth)acrylate.

The (meth)acrylate notation here denotes not only methacrylate, such as methyl methacrylate, ethyl methacrylate, etc., but also acrylate, such as methyl acrylate, ethyl acrylate, etc., and also mixtures of both.

The microparticles of the invention can be prepared preferably by emulsion polymerization and preferably have an average particle size of 100 to 5000 nm; an average particle size of 200 to 2000 nm. Maximum preference is given to average particle sizes of 250 to 1000 nm.

The average particle size is determined, for example, by counting a statistically significant amount of particles by means of transmission electron micrographs.

In the case of preparation by emulsion polymerization the microparticles are obtained in the form of an aqueous dispersion. Accordingly, the addition of the microparticles to the building material mixture likewise preferably takes place in this form.

During preparation and in the dispersion, the voids in the microparticles are water-filled. The particles develop their effect of increasing the resistance to frost and to freeze/thaw cycling in the building material mixture by at least partly relinquishing the water during and after the hardening of the building material mixture, giving correspondingly gas-filled or air-filled hollow spheres.

According to one preferred embodiment the microparticles used are composed of polymer particles which possess a core (A) and at least one shell (B), the core/shell polymer particles having been swollen by means of a base.

The core (A) of the particle contains one or more ethylenically unsaturated carboxylic acid (derivative) monomers which permit swelling of the core; these monomers are preferably selected from the group of acrylic acid, methacrylic acid, maleic acid, maleic anhydride, fumaric acid, itaconic acid and crotonic acid and mixtures thereof. Acrylic acid and methacrylic acid are particularly preferred.

The shell—where appropriate, outermost shell—B comprises, in accordance with the invention, the stated monomers.

Where the microparticles are constructed as multi-shelled particles or as gradient lattices, there are no particular restrictions on the monomers used between core and outermost shell.

The preparation of these polymeric microparticles by emulsion polymerization and their swelling by means of bases such as alkali or alkali metal hydroxides and also ammonia or an amine are likewise described in European patents EP 22 633 B1, EP 735 29 B1 and EP 188 325 B1.

The polymer content of the microparticles used may be situated, as a function of the diameter and the water content, at 2% to 98% by weight (weight of polymer relative to the total weight of the water-filled particle).

Polymer contents of 2% to 60% by weight are preferred, polymer contents of 2% to 40% by weight are particularly preferred.

Within the scope of the present invention it is entirely possible to add the water-filled microparticles directly as a solid to the building material mixture. For that purpose the microparticles—as described above—are coagulated and isolated from the aqueous dispersion by standard methods (e.g. filtration, centrifuging, sedimentation and decanting) and the particles are subsequently dried.

The water-filled microparticles are added to the building material mixture in a preferred amount of 0.01% to 5% by volume, in particular 0.1% to 0.5% by volume. The building material mixture, in the form for example of concrete or mortar, may in this case include the customary hydraulically setting binders, such as cement, lime, gypsum or anhydrite, for example.

A substantial advantage through the use of the water-filled microparticles is that only an extremely small amount of air is introduced into the concrete. As a result, significantly improved compressive strengths are achievable in the concrete. These are about 25%-50% above the compressive strengths of concrete obtained with conventional air entrainment. Hence it is possible to attain strength classes which can otherwise be set only by means of a substantially lower water/cement value (w/c value). Low w/c values, however, in turn significantly restrict the processing properties of the concrete in certain circumstances.

Moreover, higher compressive strengths may make it possible to reduce the cement content of the concrete that is needed for strength to develop, and hence may mean a significant reduction in the price per m³ of concrete.

1. Use of polymeric microparticles, containing a void, in hydraulically setting building material mixtures, characterized in that the shell of the microparticles is composed more than 99% by weight of monomers having a water solubility of less than 10⁻¹ mol/l.

2. Use of polymeric microparticles, containing a void, in hydraulically setting building material mixtures according to claim 1, characterized in that the shell of the microparticles is composed exclusively of monomers having a water solubility of less than 10⁻¹ mol/l.

3. Use of polymeric micropaticles, containing a void, according to claim 1, characterized in that the outer shell contains styrene.

4. Use of polymeric micropaticles, containing a void, according to claim 1, characterized in that the outer shell contains styrene and/or n-hexyl (meth)acrylate and/or n-butyl (meth)acrylate and/or isobutyl (meth)acrylate and/or propyl (meth)acrylate and/or ethyl methacrylate and/or ethylhexyl (meth )acrylate.

5. Use of polymeric microparticles, containing a void, according to claim 1, characterized in that the microparticles are composed of polymer particles which comprise a polymer core (A), which is swollen by means of an aqueous base and contains one or more unsaturated carboxylic acid (derivative) monomers, and a polymer envelope (B), which is composed predominantly of nonionic, ethylenically unsaturated monomers.

6. Use of polymeric microparticles, containing a void, according to claim 5, characterized in that the unsaturated carboxylic acid (derivative) monomers are selected from the group of acrylic acid, methacrylic acid, maleic acid, maleic anhydride, fumaric acid, itaconic acid and crotonic acid.

7. Use of polymeric microparticles, containing a void, according to claim 1, characterized in that the microparticles have a polymer content of 2% to 98% by weight.

8. Use of polymeric microparticles, containing a void, according to claim 1, characterized in that the microparticles have an average particle size of 100 to 5000 nm.

9. Use of polymeric microparticles, containing a void, according to claim 8, characterized in that the microparticles have an average particle size of 200 to 2000 nm.

10. Use of polymeric microparticles, containing a void, according to claim 9, characterized in that the microparticles have an average particle size of 250 to 1000 nm.

11. Use of polymeric microparticles, containing a void, according to claim 1, characterized in that the microparticles are used in an amount of 0.01% to 5% by volume, based on the building material mixture.

12. Use of polymeric microparticles, containing a void, according to claim 11, characterized in that the microparticles are used in an amount of 0.1% to 0.5% by volume based on the building material mixture.

13. Use of polymeric microparticles, containing a void, according to claim 1, characterized in that the building material mixtures are composed of a binder selected from the group of cement, lime, gypsum and anhydrite.

14. Use of polymeric microparticles, containing a void, according to claim 1, characterized in that the building material mixtures are concrete or mortar.
